(19) United States
(12) Patent Application Publication
(10) Pub. No.: US 2017/0044419 A1
(43) Pub. Date: Feb. 16, 2017

(54) Methods And Compositions For Suspending Components In Oils Without Suspending Agents

(71) Applicant: RadixKhem, LLC, Missouri City, TX (US)

(72) Inventor: Manjit S Chowdhary, Missouri City, TX (US)

(73) Assignee: RadixKhem, LLC, Missouri City, TX (US)

(21) Appl. No.: 15/307,042

(22) PCT Filed: Apr. 30, 2015
(86) PCT No.: PCT/US15/28588

§ 371 Date: Oct. 27, 2016

Related U.S. Application Data
(60) Provisional application No. 61/986,618, filed on Apr. 30, 2014.

(51) Int. Cl. C09K 8/035; C09K 8/32

(52) U.S. Cl. CPC C09K 8/035; C09K 8/32

(57) ABSTRACT

Methods and compositions for a suspending-agent free suspension may include one or more solids having at least 30 wt % of the suspending-agent free suspension being suspended in one or more oils. The one or more solids may be, for example, proppants, oxidizers, reducers, gums, starches, minerals, resins, and/or polymers, and the foregoing one or more solids may exist in various forms, including, for example, gelatinous, encapsulated, powder, crystalline, fine, course, natural, flake, or combinations el thereof. The one or more oils may be natural, synthetic, or combinations of both natural and synthetic oils. The one or more oils may or be free from benzene, toluene, ethylbenzene, and xylene, i.e., BTEX-free. The one or more oils may also include one or more viscosified oils through the addition of comprise one or more polymers. The suspending-agent free suspension may include one or more surfactants.

### CROSS-REFERENCE TO RELATED APPLICATION

The present application claims priority to U.S. provisional patent application Ser. No. 61/986,618 filed on Apr. 30, 2014.

### FIELD OF DISCLOSURE

This disclosure generally pertains to methods and compositions for suspending components, in the form of powder, granules, crystal and/or otherwise, in one or more oils and without the use of suspending agents (i.e., suspending-agent free).

### BACKGROUND

A suspension may be described as a heterogeneous mixture having solids dispersed throughout the dispersed phase, i.e., often solid, suspended in a dispersion medium e.g., solids, liquids and/or gases. Suspended particles in the suspension will settle over time if left undisturbed, and, thus, dispersion and thermal stability are important properties of a suspension. The suspension, itself, may be formed by mixing, whether manually, via high-speed mixing, or otherwise agitating in order to form a slurry.

Oftentimes, suspending agents are used to assist in suspension formation. suspending agent may be defined as an amorphous and/or fibrous material that is used to impart viscosity and suspension properties to a mixture, such as a suspension that has an oil-based carrier like an oil-based drilling fluid suspension. The suspending agent promotes stable suspensions and increased suspension of solids in the dispersion medium. Promotion of at least stability and increased, suspended solids that are functional, as opposed to objectionable, provide improved drilling fluids for use, for example, in preventing formation damage. Furthermore, such improved drilling fluids cost less because suspending agents are not required.

### SUMMARY

In one embodiment, there is disclosed a suspending-agent free suspension, which may include one or more solids having at least 30 wt % of the suspending-agent free suspension being suspended in one or more oils. The one or more solids may be, for example, proppants, oxidizers, reducers, gums, starches, minerals, resins, and/or polymers, and the foregoing one or more solids may exist in various forms, including, for example, gelatinous, encapsulated, powder, crystalline, fine, course, natural, flake, or combinations thereof The one or more oils may be natural, synthetic, or combinations of both natural and synthetic oils. The one or more oils may or be free from benzene, toluene, ethylbenzene, and xylene, i.e., BTEX-free. The one or more oils may also include one or more viscosified oils through the addition of comprise one or more polymers. The suspending-agent free suspension may include one or more surfactants.

In another embodiment, disclosed is a suspending-agent free suspension method. The method includes mixing one or more polymers with one or more oils to form a carrier Further, the method includes adding one or more solids to the carrier to form the suspending-agent free suspension, wherein the one or more solids comprise at least 30 wt % of the suspending-agent free suspension. In further embodiments, the method may include adding one or more polymers to the carrier to viscosity the carrier, adding one or more surfactants, and/or adding one or more compounds to treat fish-eye.

### DETAILED DESCRIPTION

Disclosed are methods and compositions for suspending up to at least 70 wt % or more of solids, without the user of suspending agents, such as organophilic clays, in a carrier comprising one or more oils that are viscosified with one or more polymers, wherein these compositions may be used, for example, in the oil and gas industry as part of the fluids used in subterranean formations to recover hydrocarbons. Suspending agents may cause formation damage, which results in time, material, and cost inefficiencies in production of oil or gas. The methods and compositions disclosed herein may assist in preventing formation damage and/or negating the foregoing inefficiencies experienced with suspending agents to result, potentially, in comparatively increased production of oil or gas. Another feature of the disclosed technology is that one or more solids suspended in the carrier provide for stable suspensions, some of which have shelf lives of months to years, a fact that enables shipment of suspended carrier systems over great distances and time with the solids remaining suspended, at least substantially, within the carrier. This dispersion stability, for example, may exist at elevated temperatures, such as 55° C., and/or without freezing above 0° C. And yet another feature of the disclosed technology is that the manufacturing costs of suspending one or more solids in the carrier, as disclosed herein, may be substantially the same or lower as suspending one or more solids in existing systems. Thus, the disclosed compositions and methods provide for excellent suspendability, without the use suspending agents, of one or more solids at high concentrations that are thermally stable over time, cost-competitive, and easily achieved methodologically.

The one or more oils may range from light to heavy, and may include, for example, mineral oils which may or may not include benzene, toluene, ethylbenzene, and xylene (“BTEX”) volatile aromatic compounds, vegetable oils, natural oils synthetic oils, and diesel. Example oils that may be used are available from ExxonMobil® Chemical, Sasol®, Chevron Phillips® Chemical, Shell®, Conoco®, Citgo®, and many other sources.

The one or more polymers for viscosifying the one or more oils may be synthetic, chemically modified, natural, ores, organic, and/or inorganic polymers, and exist in any form, e.g., liquid, gelatinous, encapsulated, powder, crystalline, tine, course, natural, flakes, etc. Example viscosifiers include, but are not limited to, oil-soluble polymers, polyamide resins, and polycarboxylic acids sulfonated elastomeric polymers, and soaps, wherein a suspending agent within these examples is unnecessary to achieve suspension of the one or more solids in the viscosified oils. The sulfonated elastomer polymeric viscosifier may be derived from an elastomer polymer selected from a group comprising ethylene-propylene-diene monomer (EPDM) terpolymers, copolymers of isoprene and styrene sulfonate salt, copolymers of chloroprene and styrene sulfonate salt, copolymers of isoprene and butadiene, copolymers of styrene and styrene sulfonate salt, copolymers of butadiene and styrene sulfonate salt, copolymers of butadiene and styrene, terpolymers of isoprene, styrene, and styrene sulfonate salt, terpolymers of butadiene, styrene, and styrene sulfonate salt, butyl rubber, partially hydrogenated polyisoprenes, partially hydrogenated polybutylene, partially hydrogenated natural rubber, partially hydrogenated bona rubber, partially hydrogenated polybutadienes, and/or Neoprene®.

Increasing the viscosity of the oil is possible through addition of one or more compounds, e.g., foregoing polymers that are miscible with the foregoing one or more oils. Generally, the polymer is hygroscopic and not free-flowing, which may be remedied by treating the polymer to prevent fish-eye. In other embodiments, the polymer is not treated.

The one or more solids that are suspended without the use of suspending agents in the viscosified oils may be natural, synthetic, organic, and inorganic solids. For example, and by no means limiting, in addition to suspending guar, guar-based derivatives, cellulose, cellulose-based derivatives, ores, polyacrylamides, polysaccharides, and/or ulexite of all different types and grades, including the colemanite-type of ulexite or other type of modified ulexite, one may easily suspend proppants, such as treated sand or man-made ceramic materials. Even oxidizers and reducers, which are not easy to handle as a powder, could easily be suspended in the disclosed methods and compositions. The suspended compounds, themselves, in the viscosified oil i.e., carrier), may be in any form, e.g., powder, crystalline, fine, course natural, etc. Optionally, a suspension may be assisted with one or more surfactants.

The following examples demonstrate that the one or more oils were viscosified using synthetic polymers to form the carrier. These mineral oils, themselves, were viscosified using 1-10 wt % of the viscosifiers, which were one or more synthetic polymers. Suspending properties depend, for example, upon the viscosity of the oil after viscosifying with the one or more polymers, the nature of the one or more solids to be suspended the form of the one or more solids, and the density of the one or more solids. Suspension varied from 1 wt % to 70 wt %.

In example 1, a 50% suspension of xanthan gum (i.e., the solid) was made using a 2.5% solution of styrene butadiene (“STB”) made available from Kraton® in Escaid™ 110 oil made available made available by ExxonMobil®. The xanthan gum was added to the carrier to make this 50% suspension.

In example 2, a 5% to 70% suspension of xanthan gum (i.e., the solid) as made using a 2.25% solution of STB made available from Kraton® in Escaid™ 110 oil made available made available by ExxonMobil®. The xanthan gum was mixed into the mixed carriers to make this 65% to 70% suspension.

In example 3, 50% suspensions of guar gum (i.e., the solid) was achieved by creating a carrier that included a 2.25% solution of SIB made available from Kraton and then a 2.5% solution of STB made available from Kraton®, wherein each STB solution was in either Escaid™ 110 oil made available made available by ExxonMobil® or ODC®-15 oil made available by Sasol®. The guar gum was mixed into each of these mixed carriers to make these 50% suspensions.

In example 4, a 50% suspension of xanthan gum (i.e., the solid) and a 50% suspension of guar gum (i.e., the solid) were achieved by creating a carrier that included a 2.5% solution STB made available from Kraton® in Escaid™ 110 oil made available made available by ExxonMobil®. Either gum was mixed in the carrier until a thin, flowable slurry resulted. Either gum was mixed into the mixed carrier to make the 50% suspensions.

In example 5, a 40% suspension of WEL-STAR™ HT starch (i.e., the solid) made available by Weatherford® suspended in a carrier comprising a solution of 2.5% STB made available from Kraton® in Escaid™ 110 oil made available made available by ExxonMobil®. The starch was mixed into the mixed carrier to make this 40% suspension.

In example 6, 52% suspensions of ulexite (i.e., one achieved using ulexite in a fine form and another achieved using ulexite in a course form) were suspended in a 2.5% solution of STB made available from Kraton® and Escaid™ 110 oil made available made available by ExxonMobil®. A surfactant blend of less than 0.5% was added. The ulexite, in either form, was mixed into each of the mixed carriers to make these 52% suspensions.

In example 7, a 50% suspension of a coarse polyacrylamide compound (i.e., the solid) was achieved using a 2.5% solution of STB made available from Kraton® in ODC®-15 oil made available by Sasol®. The polyacrylamide was mixed into the mixed carrier to make this suspension.

In example 8, 50% suspensions of one or more proppants of different or the same grades and/or types (e.g., WI-004, Ottawa 30/50, Ottawa 20/40, Venedo collection proppant 40/70, and ceramic proppant) were suspended in 2.75% solutions of STB made available from Kraton® in ODC®-15 oil made available by Sasol®. The proppants were mixed into each of these mixed carriers to make these 50% suspensions.

In example 9, 65% to 70% suspensions of treated (e.g., siliconized) xanthan gum (i.e., the solid) were made using 2.25% solutions of STB made available from Kraton® in ODC® and ODC®-15 oils, both of which are made available by Sasol®. The treated xanthan gum was mixed into each of these mixed carriers to make these 65% to 70% suspensions.

1. A suspending-agent free suspension comprising:
one or more solids comprising at least 30 wt. % of the suspending-agent free suspension, wherein the one or more solids are suspended in one or more oils viscosified with one or more polymers comprising 10 wt. % or less of the suspending-agent free suspension,
wherein the suspending-agent free suspension has a dispersion stability within a range of months to years.

2. (canceled)

3. The suspending-agent free suspension of claim 1, further comprising a temperature stability within a range of from 0° C. to 55° C.

4. The suspending-agent free suspension of claim 1, further comprising one or more surfactants.

5. The suspending-agent free suspension of claim 1, wherein the one or more polymers is selected from a group comprising ethylene-propylene-diene monomer (EPDM) terpolymers; copolymers of isoprene and styrene sulfonate salt; copolymers of chloroprene and styrene sulfonate salt; copolymers of isoprene and butadiene; copolymers of styrene and styrene sulfonate salt; copolymers of butadiene and styrene sulfonate salt; copolymers of butadiene and styrene; terpolymers of isoprene, styrene, and styrene sulfonate salt; terpolymers of butadiene, styrene, and styrene sulfonate salt; butyl rubber; partially hydrogenated polyisoprenes; partially hydrogenated polybutylene; partially hydrogenated natural rubber; partially hydrogenated buna rubber; partially hydrogenated polybutadienes; or Neoprene®.

6. The suspending-agent free suspension of claim 1, wherein the one or more polymers is miscible with the one or more oils.

7. The suspending-agent free suspension of claim 1, wherein the one or more polymers is hygroscopic.

8. The suspending-agent free suspension of claim 1, wherein the one or more polymers is treated to prevent fish-eye.

9. The suspending-agent free suspension of claim 1, wherein the one or more solids have one or more forms comprising gelatinous, encapsulated, powder, crystalline, fine, course, natural, flake, or combinations thereof.

10. The suspending-agent free suspension of claim 1, wherein the one or more solids comprise one or more proppants, oxidizers, reducers, gums, starches, minerals, resins, and polymers.

11. The suspending-agent free suspension of claim 1, wherein the one or more oils comprise natural, synthetic, or combinations thereof.

12. The suspending-agent free suspension of claim 1, wherein the one or more oils comprise oils free from benzene, toluene, ethylbenzene, and xylene.

13. The suspending-agent free suspension of claim 1, wherein the one or more oils comprise diesel or other petrochemicals.

14. (canceled)

15. The suspending-agent free suspension of claim 1, wherein the one or more solids are natural, synthetic, organic, inorganic solids, or combinations thereof.

16. (canceled)

17. A suspending-agent free suspension method comprising:
mixing one or more polymers with one or more oils to form a carrier; and
adding one or more solids to the carrier to form the suspending-agent free suspension wherein the one or more solids comprise at least 30 wt % of the suspending-agent free suspension and the one or more polymers comprise 10 wt % or less of the suspending-agent free suspension,
wherein the suspending-agent free suspension has a dispersion stability within a range of months to years.

18. The suspending-agent free suspension method of claim 17, further comprising adding one or more surfactants.

19. The suspending-agent free suspension method of claim 17, further adding one or more compounds to treat fish-eye.

20. The suspending-agent free suspension method of claim 17, further comprising further mixing, subsequent to the mixing and the adding, until forming a slurry.

21. The suspending-agent free suspension of claim 1, wherein the one or more solids comprise at least 50 wt. % of the suspending-agent free suspension.

22. The suspending-agent free suspension of claim 1, wherein the one or more solids comprise at least 65 wt. % of the suspending-agent free suspension.

23. The suspending-agent free suspension of claim 1, wherein the one or more polymers comprises a solution having a range of from 2.25 to 2.75 wt. % of styrene butadiene.
